(19) United States
(12) Patent Application Publication
(10) Pub. No.: US 2020/0158358 A1
(43) Pub. Date: May 21, 2020

(54) Air Intelligent Circulation Filter Window for Confined Space

(71) Applicant: Wai Kit Victor CHOI, Hong Kong (HK)

(72) Inventor: Wai Kit Victor CHOI, Hong Kong (HK)

(21) Appl. No.: 16/236,614

(22) Filed: Dec. 30, 2018

(30) Foreign Application Priority Data
Nov. 19, 2018 (CN) 201811378490.3

(51) Int. Cl. F24F 11/00; E06B 7/10; E06B 3/26; F24F 1/031; F24F 1/0358; F24F 1/037; B01D 46/00; B01D 46/42; B01D 46/46

(52) U.S. Cl. CPC F24F 11/00; E06B 7/10; E06B 3/26; F24F 1/031; F24F 1/0358; E06B 2007/023; B01D 46/0027; B01D 46/4263; B01D 46/46; B01D 46/0019; F24F 1/037

(57) ABSTRACT

The invention relates to an air intelligent circulation filter window for confined space which includes a window, an air blowing device and a circulation filtration device. The window includes an upper window frame, a lower window frame and support plates. The air blowing device includes an exhaust humidifying mechanism and a first sensor group. The exhaust humidifying mechanism includes a humidifying water tank, a first air pump, a mixer and a first air filter. The circulation filtration device includes a first filter pump, a plurality of heat exchange cavities, a second filter pump and a second sensor group. The first filter pump and the second filter pump respectively include a second air pump, a second air filter, and an air outlet. The heat exchange cavities are provided with heat exchange tubes. The an air intelligent circulation filter window for confined space of the present invention has the advantages of simple structure, convenient to use, energy saving and environmental protection, small occupied area and high intelligence degree which effectively solves the problem that the existing confined space window without ventilation does not have temperature control function.

### FIELD OF THE INVENTION

The invention relates to the field of smart home appliances, in particular to an air intelligent circulation filter window for confined space.

### BACKGROUND

In the known technology, a clean room, a dust-free workshop, and the like have special requirements, and the space is often closed, so the windows installed in a clean room, a clean room, and the like usually do not have the functions of ventilation and temperature control. In order to prevent people from entering and leaving the environment, workers also need to wear special sealed clothing, which is very stuffy. Therefore, air filtration devices, ventilation devices and temperature control devices are usually required in places such as clean rooms and dust-free workshops. In addition, in the high-rise office buildings, integrated commercial buildings and urban landmark super high-rise building exterior walls, the glass curtain wall with the overall structure is also used for sealing, and there are also shortcomings such as difficulty in opening windows and poor ventilation performance.

At present, the common air filtration devices, ventilation devices and temperature control devices are often split-type structures, which have low intelligence, large power consumption, and occupy a large space, and are easy to accumulate dirt in the ventilation pipes after long-term use. It is easy to pollute the confined environment and it is very troublesome to clean up.

### SUMMARY OF THE INVENTION

The technical problem to be solved is to overcome the above-mentioned deficiency by providing an air intelligent circulation filter window for confined space, which has the advantages of simple structure, convenient to use, energy saving and environmental protection, small occupied area and high intelligence degree which effectively solves the problem that the existing confined space window without ventilation does not have temperature control function.

The technical solution of the present invention is provide an air intelligent circulation filter window for confined space which includes a window, an air blowing device and a circulation filtration device. The window includes an upper window frame and a lower window and two support plates. The upper window frame and the lower window frame are symmetrically arranged up and down, and the support plate is vertically symmetrically disposed between the upper window frame and the lower window frame. The upper and lower ends of the support plate are respectively fixedly connected to each other.

The upper window frame is provided with a first cavity having a downward opening. The lower window frame is provided with a second cavity having an upward opening and a third cavity disposed beneath the second cavity. The support plate is a U-shaped structure, and the notches of the two support plates are opposite to each other. The first cavity, the second cavity and the groove of the support plate are axially provided with the protrusions. The protrusions are inlaid with the glass. An electric heating wire is provided between the glass and the protrusions.

A through hole is formed in the protrusion in the first cavity. A first cover and a second cover are respectively disposed on two sides of the opening of the second cavity separated by the glass.

The air blowing device is disposed in the first cavity. The air blowing device includes an exhaust humidifying mechanism, and a first sensor group. The exhaust humidifying mechanism includes a humidifying water tank, a first air pump, a mixer, and a first air filter. The mixer is a first housing having a tapered inner cavity. The inner cavity of the first housing is provided with a thread. The humidifying water tank is provided with an ultrasonic transducer. An air inlet of the first air pump and the first air filter are connected. The air outlet of the first air pump and the humidifying water tank are respectively connected with the first interface and the second interface on the first housing. The other end of the mixer is connected with the through hole.

The circulation filtration device is disposed in the third cavity, and the circulation filtration device includes a first filter pump, a plurality of heat exchange cavities, a second filter pump, and a second sensor group. The first filter pump and the second filter pump respectively include a second air pump, a second air filter connected to the air outlet of the second air pump, an air outlet connected to the second air filter. The second air filter on the second filter pump is provided with an electromagnetic valve.

The air inlet of the second air pump and the second cavity are in communication with each other. The heat exchange cavity is coiled with a heat exchange tube, and both ends of the heat exchange tube are connected with the air compressor. The surface of the air compressor is provided with an electric cooling plate. The heat exchange cavities are respectively connected to the air outlet.

Further, the lower window frame is provided with a baffle, and the upper end of the baffle is hinged to the lower window frame.

Further, the first cover is made of a mesh plate.

Further, a central portion of the second cover is provided with a through slot, and a plurality of blades are hinged with a hinge shaft in the through slot.

Further, a refrigerant is disposed in the heat exchange tube.

Further, the first air filter and the second air filter include a sealed housing filled with a solid or liquid or solid-liquid mixed filter medium.

Further, the first sensor group and the second sensor group respectively include a carbon monoxide sensor, a PM sensor, and a temperature and humidity sensor.

Further, the circulation filtration device further includes a controller, and the controller is respectively electrically connected with the first sensor group, the second sensor group, the ultrasonic transducer, the first air pump, the second air pump, the electromagnetic valve, the air compressor, and the electric cooling plate.

The technical effect of the present invention is to provide an air intelligent circulation filter window for confined space which includes a window, an air blowing device and a circulation filtration device. The air blowing device and the circulation filtration device are arranged on the window. The air blowing device uses the air pump to absorb the air into the external environment and mix the atomized water vapor into the room. On one hand, the circulation filtration device extracts the air in the room for filtering and temperature control. On the other hand, the circulation filtration device discharges the dirty air in the room to the outside. It has the advantages of simple structure, convenient to use, energy saving and environmental protection, small occupied area and high intelligence degree which effectively solves the problem that the existing confined space window without ventilation does not have temperature control function.

### BRIEF DESCRIPTION OF THE DRAWINGS

The invention is illustrated by the following figures and embodiments.

FIG. 1 shows a schematic diagram of whole structure of an air intelligent circulation filter window for confined space.

FIG. 2 shows a schematic diagram of a window of an air intelligent circulation filter window for confined space.

FIG. 3 shows a schematic diagram of a cover of an air intelligent circulation filter window for confined space.

FIG. 4 shows a schematic diagram of air blowing device of an air intelligent circulation filter window for confined space.

FIG. 5 shows a schematic diagram of inner side of circulation filtration device of an air intelligent circulation filter window for confined space.

FIG. 6 shows a schematic diagram of outside of circulation filtration device of an air intelligent circulation filter window for confined space.

FIG. 7 shows a schematic diagram of second filter pump of an air intelligent circulation filter window for confined space.

FIG. 8 shows a schematic diagram of a mixer of an air intelligent circulation filter window for confined space.

The reference numbers of the figures are as follows:
1: window; 11: upper window frame; 111: first cavity; 112: protrusion; 113: through hole; 12: lower window frame; 121: baffle; 122: first cover; 1221: blade; 1222: hinge; 123: third cavity; 124: second cavity; 125: second cover; 126: second sensor group; 13: support plate; 14: glass; 15: electrical heating wire; 2: air blowing device; 21: exhaust humidifying mechanism; 211: humidifying water tank; 2111: ultrasonic transducer; 212: first air pump; 213: mixer; 2131: first housing; 2132: second interface; 2133: first interface; 214: first air filter; 2144: thread; 22: first sensor group; 3: circulation filtration device; 31: first filter pump; 32: heat exchange cavity; 321: heat exchange tube; 322: air compressor; 323: electrical cooling plate; 33: second filter pump; 331: second air pump; 332: second air filter; 333: electromagnetic valve; 334: air outlet; 34: controller.

### DETAILED DESCRIPTION

The invention is illustrated in accordance with figures. The figures as simplified diagrams demonstrate the basic structures of the apparatus of embodiments of the invention. Thus; the invention is not limited to the figures.

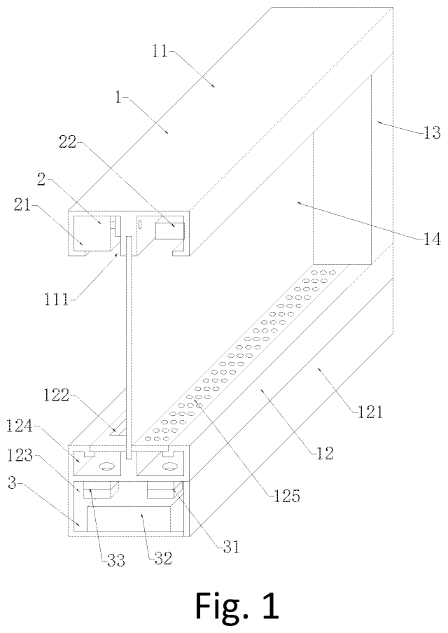

As shown in FIG. 1, an air intelligent circulation filter window for confined space includes a window 1, an air blowing device 2 and a circulation filtration device 3. In one example embodiment, the window 1 is made of alloy or plastic or a combination of alloy and plastic.

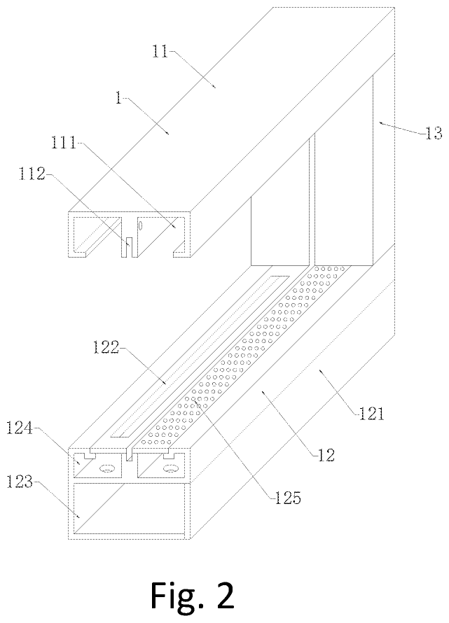

As shown in FIG. 2, the window 1 includes an upper window frame 11 and a lower window 12 and two support plates 13. The upper window frame 11 and the lower window frame 12 are symmetrically arranged up and down, and the support plate 13 is vertically symmetrically disposed between the upper window frame 11 and the lower window frame 12. The upper and lower ends of the support plate 13 are respectively fixedly connected to each other.

The upper window frame 11 is provided with a first cavity 111 having a downward opening. The lower window frame 12 is provided with a second cavity 124 having an upward opening and a third cavity 123 disposed beneath the second cavity 124. The support plate 13 is a U-shaped structure, and the notches of the two support plates 13 are opposite to each other. The first cavity 111, the second cavity 124 and the groove of the support plate 13 are axially provided with the protrusions 112. The protrusions 112 divide the first cavity 111 and the second cavity 124 into two parts. The protrusions 112 are provided with a glass hold slot.

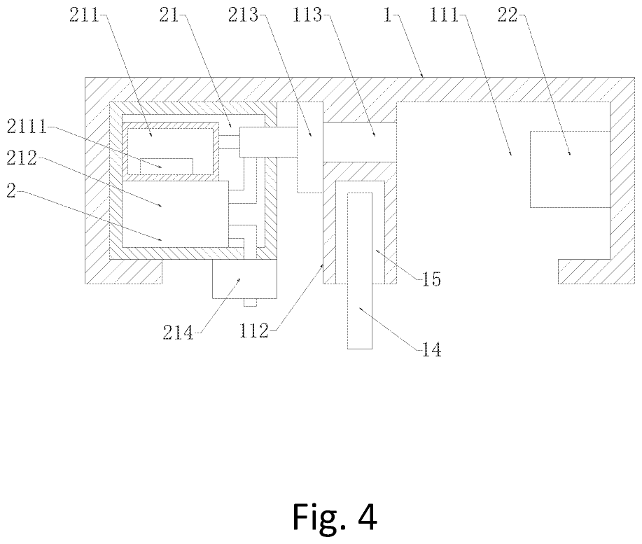

As shown in FIG. 4, the glass hold slot is inlaid with the glass 14. An electric heating wire 15 is provided between the glass 14 and the protrusions 112. The electric heating wire 15 is used to heat the glass 14 to prevent fogging on the glass 14 when there is a temperature difference between indoors and outdoors. A through hole 113 is formed in the protrusion 112 in the first cavity 111.

As shown in FIGS. 1 and 2, the opening of the second cavity 124 is separated by the glass 14 on both sides, and the first cover 122 is disposed near the outdoor side, and the second cover 125 is disposed near the indoor side.

As shown in FIG. 4, the air blowing device 2 is disposed in the first cavity 111. The air blowing device 2 includes an exhaust humidifying mechanism 21 and a first sensor group 22 near the indoor side. The exhaust humidifying mechanism 21 includes a humidifying water tank 211, a first air pump 212, a mixer 213, and a first air filter 214. An ultrasonic transducer 2111 is disposed in the humidification water tank 211. The ultrasonic transducer 2111 is used to atomize the water in the humidifying water tank 211, and the air inlet of the first air pump 212 is connected to the first air filter 214 for filtering the inhaled air.

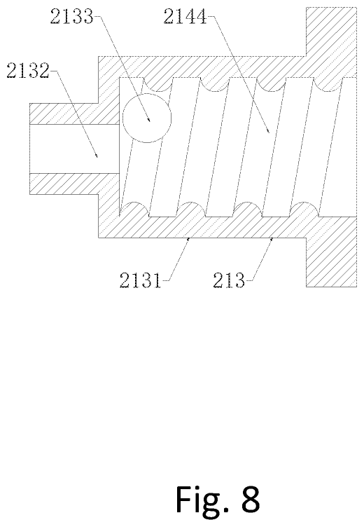

As shown in FIG. 8, the mixer 213 is a first housing 2131 having a tapered inner cavity. The inner cavity of the first housing 2131 is provided with a thread 2144. The air outlet of the first air pump 212 and the humidifying water tank 211 are respectively connected to the first interface 2133 on the first housing 2131 and the second interface 2131. The other end of the mixer 213 is connected to the through hole 113. The air blown out from the air outlet of the first air pump 212 and the atomized water vapor are rotationally mixed by the thread 2144, and then blown into the room from the through hole 113.

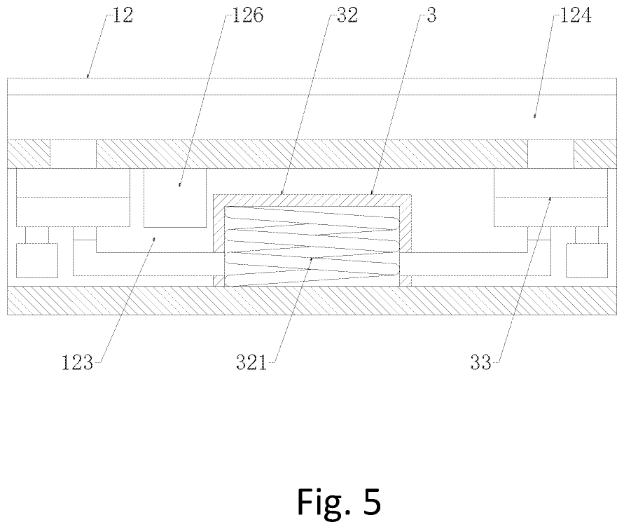

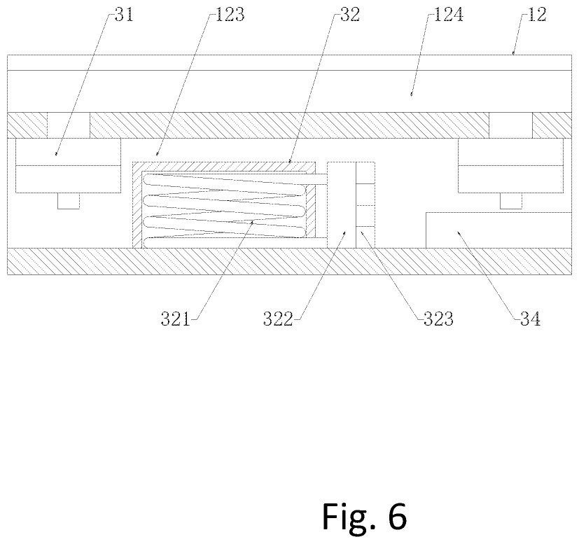

As shown in FIGS. 5 and 6, the circulation filtration device 3 is disposed in the third cavity 123, and the circulation filtration device 3 includes a first filter pump 31, a plurality of heat exchange cavities 32, a second filter pump 33, and a second sensor group 126.

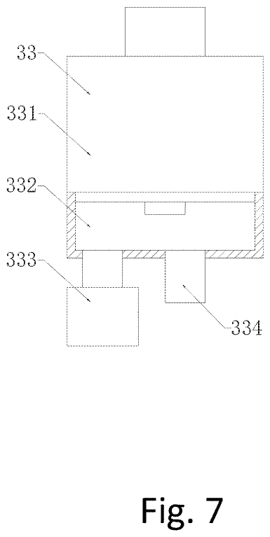

As shown in FIG. 7, the first filter pump 31 and the second filter pump 33 respectively include a second air pump 331, a second air filter 332 connected to the air outlet of the second air pump 331, an air outlet 223 connected to the second air filter 332. The second air filter 332 on the second filter pump 33 is provided with an electromagnetic valve 333.

As shown in FIGS. 1, 5 and 6, the air inlet of the second air pump 331 in the first filter pump 31 is in communication with the side of the second cavity 124 near indoors. The air inlet of the second air pump 331 in the second filter pump 33 is in communication with one side of the second cavity 124 near outdoors.

The heat exchange cavity 32 is coiled with a heat exchange tube 321, and both ends of the heat exchange tube 321 are connected with the air compressor 322. The surface of the air compressor 322 is provided with a plurality of electric cooling plates 323. The electric cooling plates 323 connects to the absorbing end and the heating dissipating end of the surface of the air compressor 322. The heat in the heat exchange tubes 321 is taken out or injected into the heat exchange tubes 321 by the heat absorption/discharge of the electric cooling plates 323. The heat exchange cavities 32 are respectively connected to the air outlet 334.

After the indoor air is absorbed and filtered by the second filter pump 33 through the second cover 125, in one example embodiment, the electromagnetic valve 333 is closed. The filtered air passes through the heat exchange cavity 32 for heat exchange, and then discharges back to the room by the second filter pump 33 so that the air temperature is adjusted. In another example embodiment, the electromagnetic valve 333 is opened. The filtered air is discharged into the third cavity 123, and discharged out of the room by the first filter pump 31 opening the first cover 122 on the second cavity 124.

In an example embodiment, the air outlet of the first air pump 212 is connected to one end of the heat exchange cavity 32 and the other end of the heat exchange cavity 32 is connected to the mixer 213.

In an example embodiment as shown in FIG. 2, the lower window frame 12 is provided with a baffle 121, and the upper end of the baffle 121 is hinged to the lower window frame 12 so that the baffle 121 can be opened to clean the inside of the cavity.

In an example embodiment, the first cover is made of a mesh plate to facilitate the air to enter.

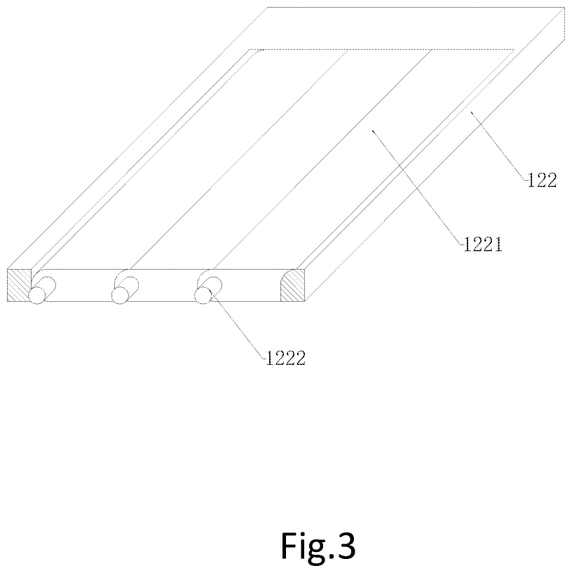

In an example embodiment as shown in FIG. 3, a central portion of the first cover 122 is provided with a through slot, and a plurality of blades 1221 are hinged with a hinge shaft 1222 in the through slot. The air can open the blades 1221 from the inside. In the opposite way, the blades 1221 is closed to prevent the sundries outdoor from falling into the second cavity 124.

In an example embodiment, a refrigerant is disposed in the heat exchange tube 321.

In an example embodiment, the first air filter 214 and the second air filter 332 include a sealed housing filled with a solid or liquid or solid-liquid mixed filter medium.

In an example embodiment, the first sensor group 22 and the second sensor group 126 respectively include a carbon monoxide sensor, a PM sensor, and a temperature and humidity sensor to measure the air quality indoor.

The circulation filtration device 3 further includes a controller 34, and the controller 34 is respectively electrically connected with the first sensor group 22, the second sensor group 126, the ultrasonic transducer 2111, the first air pump 212, the second air pump 331, the electromagnetic valve 333, the air compressor 322, and the electric cooling plate 323.

The first sensor group 22 and the second sensor group 126 send the data on air detection back to the controller 34. The controller 34 compares the data which the first sensor group 22 and the second sensor group 126 send back with the data pre-set in the controller 34, and the controller 34 controls the ultrasonic transducer 2111, the first aim pump 212, the second pump 331, the electromagnetic valve 333, the air compressor 322 and the electric cooling plate 323 to achieve the purpose of controlling air quality. For example, when the first sensor group 22 and the second sensor group 126 detect the indoor air to be too dry, the ultrasonic transducer 2111 is opened to humidify the indoor air. When the first sensor group 22 and the second sensor group 126 detects the level of the indoor carbon dioxide to be too high, the air blowing device and the circulation filtration device blow the air into the indoor and filter the air. When the first sensor group 22 and the second sensor group 126 detect the indoor temperature to be too high, the circulation filtration device is opened to control the temperature.

The air intelligent circulation filter window for confined space of the present invention has a simple structure and includes a window, an air blowing device and a circulation filtration device. The air blowing device and the circulation filtration device are arranged on the window. The air blowing device uses the air pump to absorb the air into the external environment and mix the atomized water vapor into the room. On one hand, the circulation filtration device extracts the air in the room for filtering and temperature control. On the other hand, the circulation filtration device discharges the dirty air in the room to the outside. It has the advantages of simple structure, convenient to use, energy saving and environmental protection, small occupied area and high intelligence degree which effectively solves the problem that the existing confined space window without ventilation does not have temperature control function.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

What is claimed is:

1. An air intelligent circulation filter window for confined space, comprising a window 1, an air blowing device 2 and a circulation filtration device 3, wherein the window 1 includes an upper window frame 11 and a lower window 12 and two support plates 13; the upper window frame 11 and the lower window frame 12 are symmetrically arranged up and down, and the support plate 13 is vertically symmetrically disposed between the upper window frame 11 and the lower window frame 12; the upper and lower ends of the support plate are respectively fixedly connected to each other,
wherein the upper window frame 11 is provided with a first cavity 111 having a downward opening; the lower window frame 12 is provided with a second cavity 124 having an upward opening and a third cavity 123 disposed beneath the second cavity 124; the support plate 13 is a U-shaped structure, and the notches of the two support plates are opposite to each other; the first cavity, the second cavity and the groove of the support plate are axially provided with the protrusions; the protrusions 112 are inlaid with the glass 14; an electric heating wire 15 is provided between the glass 14 and the protrusions 112,
wherein a through hole 113 is formed in the protrusion 112 in the first cavity 111; a first cover 122 and a second cover 125 are respectively disposed on two sides of the opening of the second cavity separated by the glass.
wherein the air blowing device 2 is disposed in the first cavity 111; the air blowing device 2 includes an exhaust humidifying mechanism 21, and a first sensor group 22; the exhaust humidifying mechanism 21 includes a humidifying water tank 211, a first air pump 212, a mixer 213, and a first air filter 214; the mixer 213 is a first housing 2131 having a tapered inner cavity; the inner cavity of the first housing is provided with a thread 2144; the humidifying water tank 211 is provided with an ultrasonic transducer 2111; an air inlet of the first air pump 212 and the first air filter 214 are connected; the air outlet of the first air pump 212 and the humidifying water tank 211 are respectively connected with the first interface 2133 and the second interface 2132 on the first housing 2131; the other end of the mixer 213 is connected with the through hole 113,
wherein the circulation filtration device 3 is disposed in the third cavity 123, and the circulation filtration device 3 includes a first filter pump 31, a plurality of heat exchange cavities 32, a second filter pump 33, and a second sensor group 126; the first filter pump 31 and the second filter pump 33 respectively include a second air pump 331, a second air filter 332 connected to the air outlet of the second air pump 33, an air outlet 334 connected to the second air filter 332; the second air filter 332 on the second filter pump 33 is provided with an electromagnetic valve 333,
wherein the air inlet of the second air pump 331 and the second cavity 124 are in communication with each other; the heat exchange cavity 32 is coiled with a heat exchange tube 321, and both ends of the heat exchange tube 321 are connected with the air compressor 322; the surface of the air compressor 322 is provided with an electric cooling plate 323; the heat exchange cavities are respectively connected to the air outlet 334.

2. The air intelligent circulation filter window for confined space of claim 1, wherein the lower window frame 12 is provided with a baffle 121, and the upper end of the baffle 121 is hinged to the lower window frame 12.

3. The air intelligent circulation filter window for confined space of claim 1, wherein the first cover 125 is made of a mesh plate.

4. The air intelligent circulation filter window for confined space of claim 1, wherein a central portion of the first cover 122 is provided with a through slot, and a plurality of blades 1221 are hinged with a hinge shaft 1222 in the through slot.

5. The air intelligent circulation filter window for confined space of claim 1, wherein a refrigerant is disposed in the heat exchange tube 321.

6. The air intelligent circulation filter window for confined space of claim 1, wherein, the first air filter 214 and the second air filter 332 include a sealed housing filled with a solid or liquid or solid-liquid mixed filter medium.

7. The air intelligent circulation filter window for confined space of claim 1, wherein the first sensor group 22 and the second sensor group 126 respectively include a carbon monoxide sensor, a PM sensor, and a temperature and humidity sensor.

8. The air intelligent circulation filter window for confined space of claim 1, wherein the circulation filtration device 3 further includes a controller 34, and the controller 34 is respectively electrically connected with the first sensor group 22, the second sensor group 126, the ultrasonic transducer 2111, the first air pump 212, the second air pump 331, the electromagnetic valve 333, the air compressor 322, and the electric cooling plate 323.
